(19) United States
(12) Patent Application Publication
(10) Pub. No.: US 2016/0094672 A1
(43) Pub. Date: Mar. 31, 2016

(54) SYSTEMS AND METHODS FOR IMPROVING INFORMAL PROBLEM SOLVING NETWORKS

(71) Applicant: Sorian LLC, Broadview Heights, OH (US)

(72) Inventor: John Schober, Broadview Heights, OH (US)

(73) Assignee: SORIAN LLC, Broadview Heights, OH (US)

(21) Appl. No.: 14/869,264

(22) Filed: Sep. 29, 2015

Related U.S. Application Data
(60) Provisional application No. 62/056,883, filed on Sep. 29, 2014.

(51) Int. Cl. H04L 29/08; G06F 3/0484; G06F 17/30; H04L 12/24; G06F 3/0482

(52) U.S. Cl. CPC H04L 67/22; H04L 41/22; G06F 3/0482; G06F 17/3053; G06F 3/04842

(57) ABSTRACT

The present invention is a system that: assists network-level interests in analyzing of the effectiveness of informal problem solving networks; provides data and analysis to network-level interests that can be used to justify the development and implement of improvements to the informal problem solving networks; and makes it easier for network-level interests to work in partnership with network participants to develop improvements to the network by enabling network-level interests to evaluate the impact of improvements to the informal problem solving networks.

### SUMMARY

System for analyzing the effectiveness of informal problem solving networks and implementing and evaluating improvements to the network.

### BACKGROUND

Informal problem solving networks (“IPSN”') are networks of organizations that interact to advance common interests but which are not governed/managed under a single management structure. These networks are increasingly being looked to by network participants and third parties to advance their interests. Examples of these types of networks can be found in:
economic development, e.g. resource networks to support a growing economy
business, e.g. trade associations to improve the competitiveness of an industry or industry group
government, e.g. federal, state, and local agencies collaborating to recover from natural disasters
technology clusters, e.g. regional networks to proliferate the use of an emerging technology
philanthropy, e.g. associations of non-profit organizations to advance a social mission
academia. e.g. networks of businesses and educational institutions to develop future workforce

One key characteristic of IPSN is that the solution of problems at a local level by network participants contributes to the advancement of the interests of the IPSN. Examples include:
the development of a website for a small business (local problem) helps the business grow and thus helps the local economy grow (interest of the IPSN)
changing business processes at an individual business to meet the requirements of a new regulation (local problem) helps an industry be more competitive against a competing industry (interest of the IPSN)
restarting a business after a natural disaster (local problem) helps a community recover more quickly from the natural disaster (interest of the IPSN)
adoption by a startup of a new technology (local problem) helps a technology cluster grow (interest of the IPSN)
use in a community of new vaccines (local problem) helps eradicate a new disease (interest of the IPSN)
adoption of a new academic standard by a school (local problem) helps improve the academic performance of students of across a target geography (interest of the IPSN)

Network level interests (heretofore “NLIs”) are people or organizations that take on the responsibility of or are accountable for the effectiveness of an informal problem solving network in achieving its objective(s). NLIs may be:
People or organizations who fund or provide resources for organizations in the network, especially multiple organizations in the network, but might not participate in the primary activities of the network
Participants in the network who have assumed a leadership or administrative role in the network
Participants in the network that are interested in improving their effectiveness in the network, or the effectiveness of other participants in the network.
Administrators of systems (e.g. IT systems) that support the operation of the network.

Data on the activity and output of network participants is valuable to NLIs for executing on the mission/objectives of the network, for example for:
for informing decisions on investment in the network (i.e. developing, launching, continuing, or eliminating capacities within the network),
for attracting or justifying funding to support the network
for attracting new participants

There are several methods that are conventionally used to measure the activity and output of these networks:
Surveying network participants on activities or outcomes via online tools, phone calls, in-person meetings
Surveying customers of network participants on activities or outcomes via online surveys, phone calls, in-person meetings
Tracking external variables that are assumed to be influenced by network activity and output (e.g. macro-economic metrics such as gross regional product, productivity)

These approaches are ineffective for the following reasons
Reporting and measuring is costly and time consuming for network participants and for those doing the surveys
Incentives for reporting and measuring are weak, owing to the difficulty of establishing accountability systems in an informal network and to the higher priority that network participants tend to place on organizational objectives vs network objectives
Systems to encourage reporting and measuring are difficult to design, implement, and enforce
Even when participants do report, biases are inherent, and reconciling those biases is difficult
Cause and effect relationships are difficult to establish

Because of the limitations of these approaches NLIs often struggle with monitoring the performance of the network and making productive investments in the network.

Social platforms are relatively new tools for connecting people, information, and resources that have grown in popularity with the advancement of the interne, computing, and mobile devices. From Techopedia, a definition of a social platform (www.techopedia.com/definition/23759/social-platform):
A social platform exhibits a social media network's technological and user-specific characteristics. Technologically, a social platform provides markup language for creating native applications, an application programming interface (API) for third party application integration and a backend admin console for managing the entire user base and preferences, etc. From a user's perspectives, a social platform enables communities, sharing of content, adding friends, setting privacy controls and other native social media network features.

Examples of social platforms include Facebook, LinkedIn, Twitter. Angie's List, Match.com. See FIG. 1 for model for how a social platform operates.

A more specific type of social platform has come into use recently that facilitates interactions between “seekers” and “solvers”. These platforms provide an online forum for matching people or organizations that have needs (seekers) with those that can address those needs (solvers)—see FIG. 2. HourlyNerd (www.hourlynerd.com), Skillbridge (www.skillbridge.co), and MosaicHub (www.mosaichub.com) are examples. They differ by revenue model, by targeted population of seekers, targeted population of solvers, user interface features, and others.

As interactions/transactions take place on these social platforms, data is generated that is useful for facilitating interactions between users, for example ranking/reports on the activity of a solver that is helpful in qualifying that user as a relevant solver for another user. In addition, data is generated that is useful for administration of the platform. For example, the response activity of solvers can be used to develop new features on the platform that can improve response rates. Data is also generated that can be useful to firms interested in advertising on the platform. The present invention improves upon social platforms by incorporating features that allow network level interests to use the data generated by interactions on a social platform to:
evaluate the effectiveness of a problem solving network
to develop and implement improvements to the network
to evaluate the impact of the implemented improvements on the effectiveness of a network

In effect, the inclusion of these features on a social platform establishes a feedback loop between network participants and NLIs that allows for continuous improvement in the problem solving network—see FIG. 3.

### BRIEF DESCRIPTIONS OF THE DRAWINGS

FIG. 1 illustrates how a social platform works

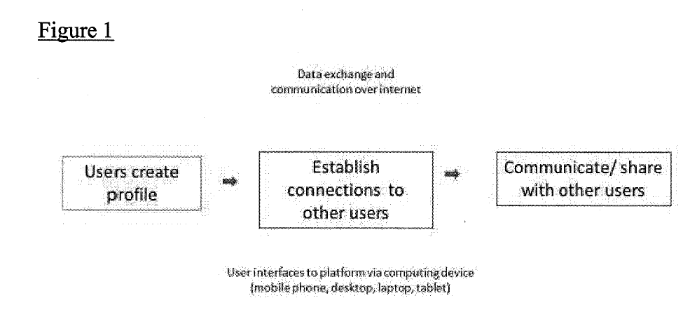

FIG. 2 illustrates how a seeker-solver social platform works

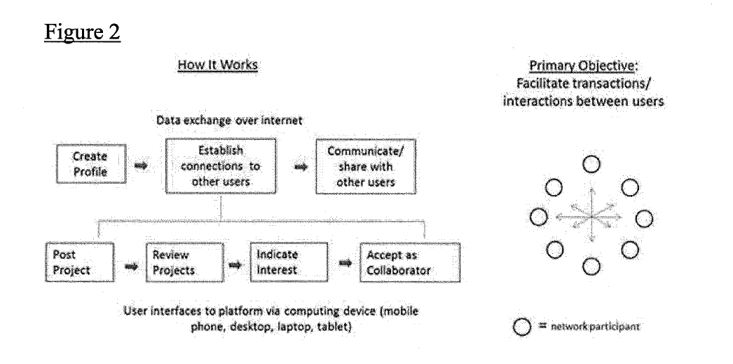

FIG. 3 illustrates a resulting feedback loop between users of platform and the NLI's

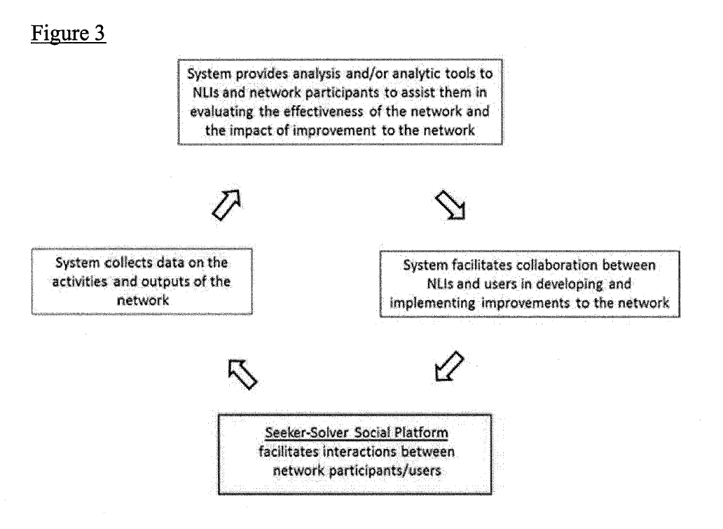

FIG. 4 illustrates an example of the creation of a profile of a user of the system

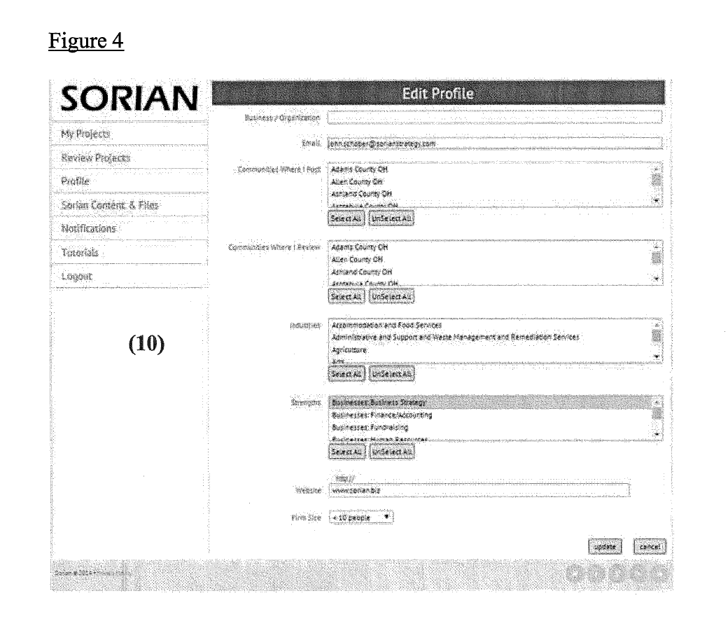

FIG. 5 illustrates an example of the creation of a project by a user of the system

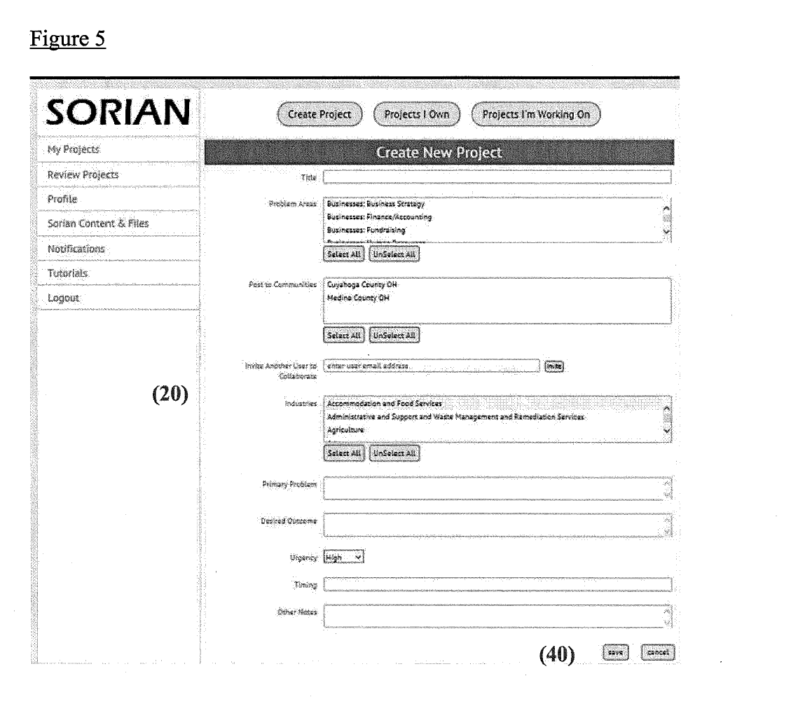

FIG. 6 illustrates an example of inputting project results by a user of the system

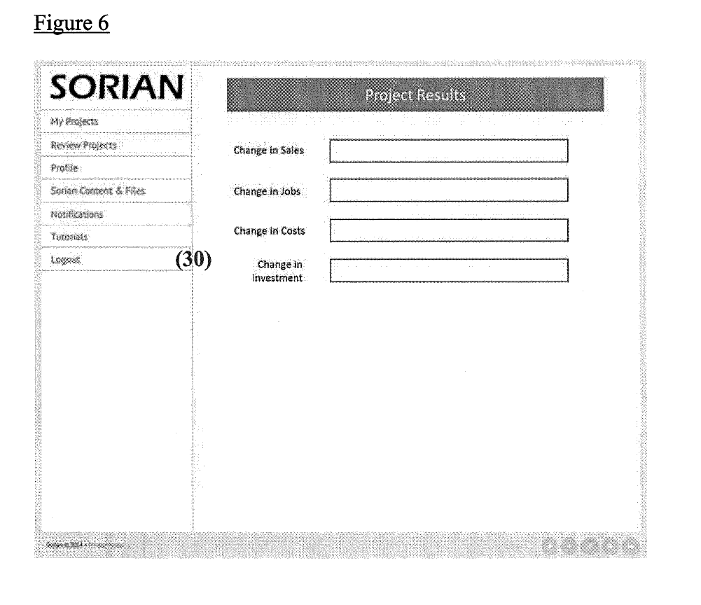

FIG. 7 illustrates an example of reviewing and responding to projects posted on the system the creation of a project by a user of the system

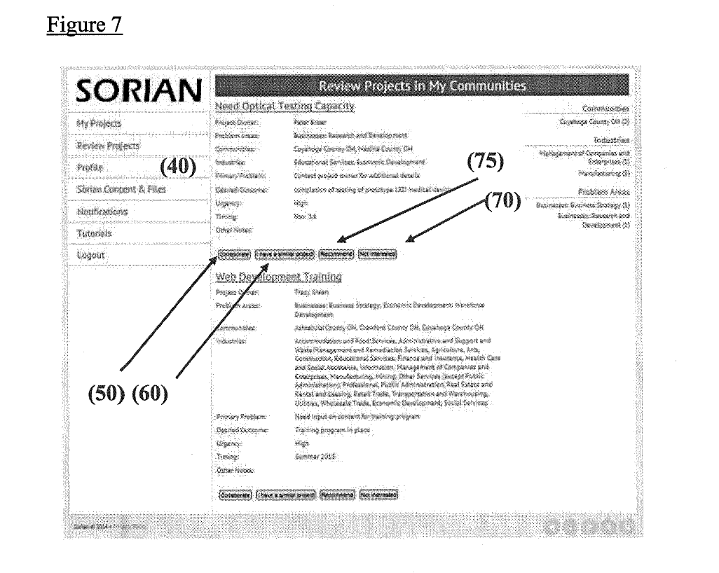

FIG. 8 illustrates an example of accepting collaborators and using collaborative tools available in the system

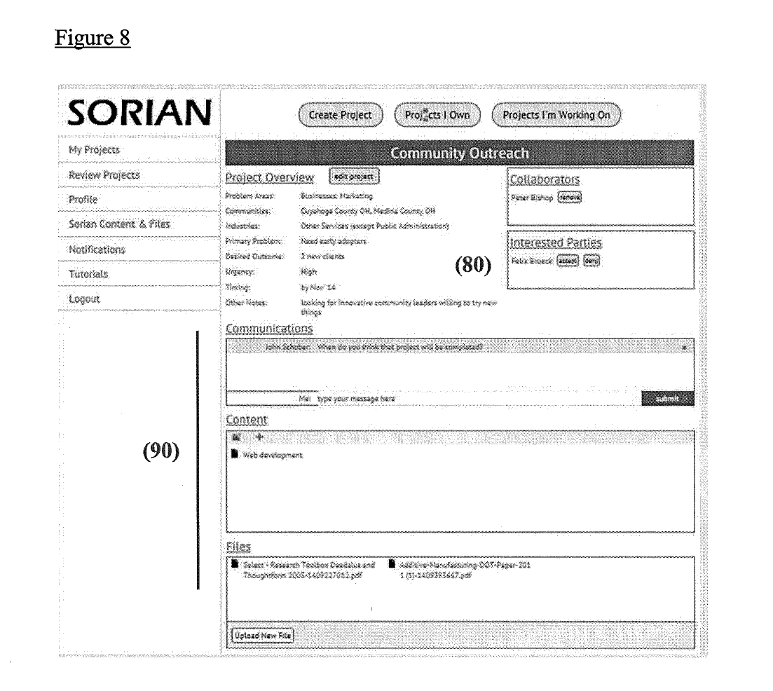

FIG. 9 illustrates an example of a report for NLI's that is generated by the system

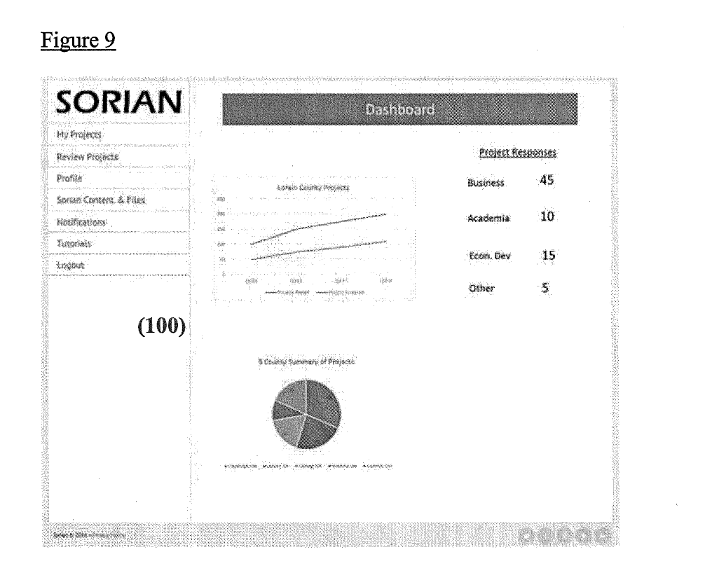

FIG. 10 illustrates an example of a welcome page or landing page to which the user is directed upon entering the system

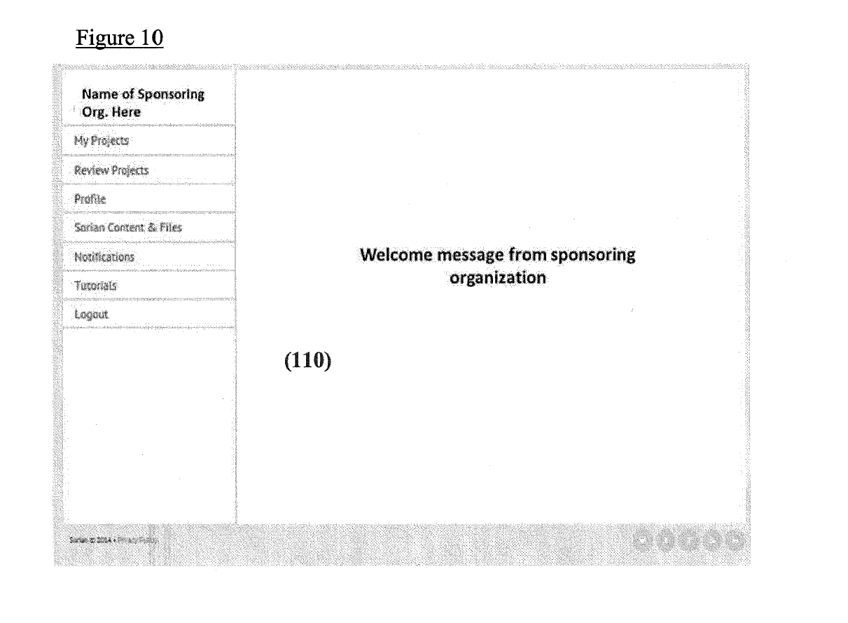

FIG. 11 illustrates an example of customized profile inputs

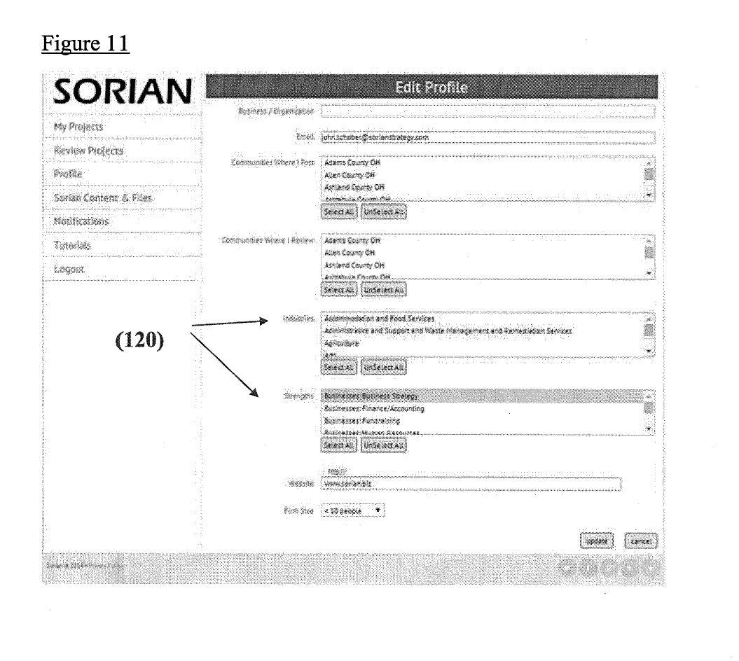

FIG. 12 illustrates an example of customized project inputs

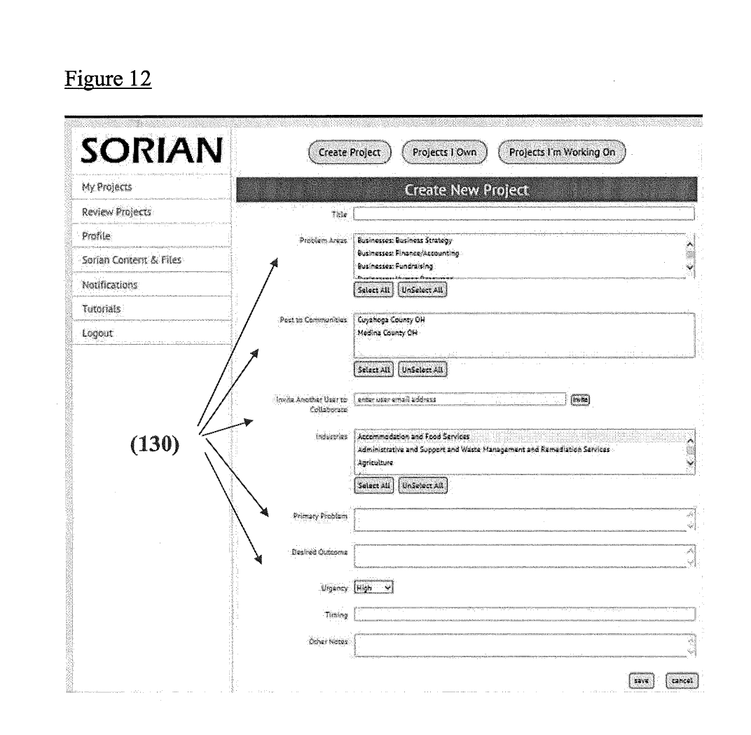

FIG. 13 illustrates an example of customized project outputs

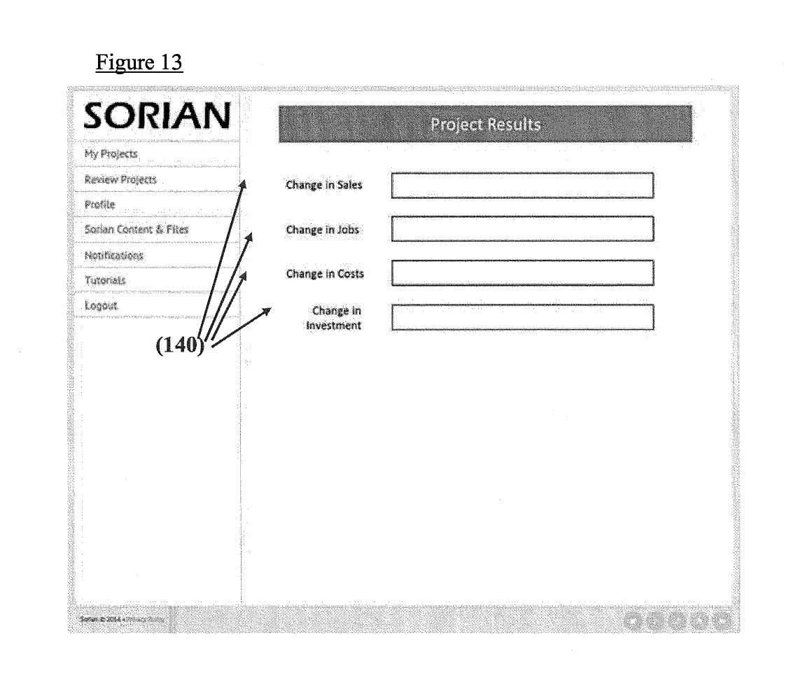

FIG. 14 illustrates an example of restricted access to portions of a profile, project, output, or collaboration data.

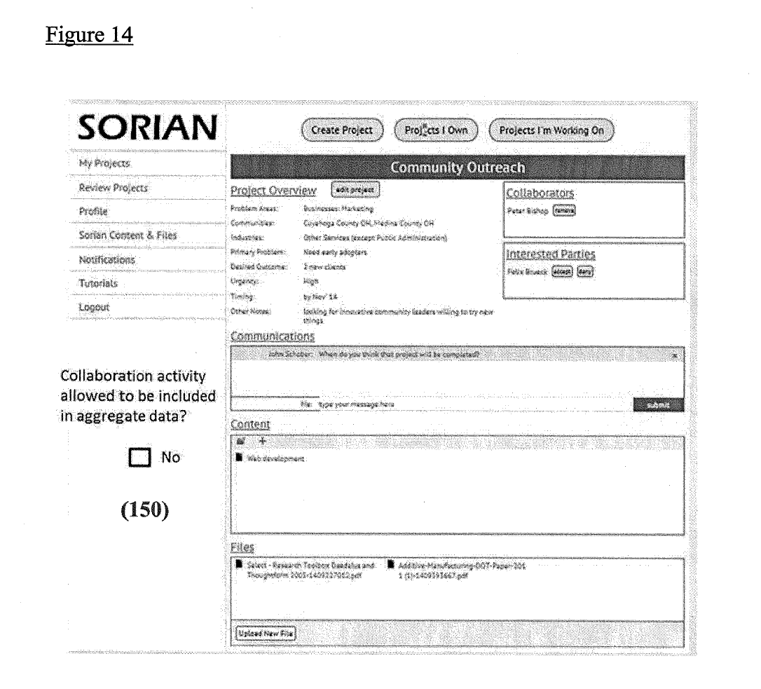

FIG. 15 illustrates an example of enabling the use of third party platform tools

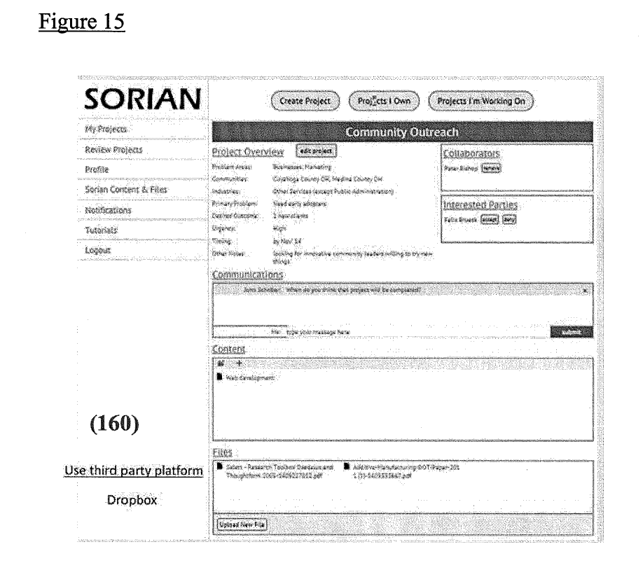

### DETAILED DESCRIPTION OF THE SYSTEM

The present invention is a system that:
assists network-level interests (“NLIs”) in analyzing of the effectiveness of informal problem solving networks (“IPSNs”).
provides data and analysis to NLIs that can be used to justify the development and implement of improvements to the IPSN
makes it easier or NLIs to work in partnership with network participants to develop and implements improvements to the network
enables NLIs to evaluate the impact of improvements to the IPSN.
Is able to host multiple IPSNs and distinguish users, activities, interactions, and outputs across the multiple IPSN's

The system can be an integral part of a social platform that is designed to support a problem solving network (e.g. a seeker solver platform), or it can be used with a social platform that was designed for other purposes, i.e. to facilitate transactions/interactions between users.

In a preferred embodiment, users input information on themselves that is relevant to NLIs and other users, for example, how to contact them, relevant geographies or industries, and relevant strengths that they bring to the network. (10) In a preferred embodiment, users input information on projects in which they would like to participate and that are relevant to NLIs (20).

Projects can be related to meeting organization-level objectives for the user. For example, in the interest of increasing market awareness of their product or service, users can post a project seeking support from other users to develop marketing strategies. Similarly, users could post projects related to engineering, information technology, human resources, business strategy, operations, accounting and others.

Projects can be related to meeting network-level objectives. For example, in the interest of creating a set of academic or training programs that will benefit the network as a whole, a user could post a project requesting input data from multiple users or a project calling for users to try out the programs. Other examples include sharing of best practices across users, pooling of resources across users, identifying common problems/projects amongst users, comparing data across users.

Projects can be need-based, i.e. user is seeking a specific service or resource

Projects can be resource-based, i.e. user is indicating availability of a specific resource for example
funding
machine capacity
best practices expertise
databases
analytic capacity
design capacity
material availability

In a preferred embodiment, users input information on the output and outcomes of their projects (30). In a preferred embodiment, users input project outputs related to their own organizational level objectives that align with network-level objectives.

In a preferred embodiment, users are prompted to post projects (described above) to other users that are relevant to NLIs (40).

In a preferred embodiment, the system enables users to indicate an interest in collaborating (50).

In a preferred embodiment, the system enables users to indicate that they have a similar issue/challenge/project (60).

In a preferred embodiment, the system enables users to refer projects to other users (70).

In a preferred embodiment, the system enables users to accept or reject proposed collaborations (80).

In a preferred embodiment, the system enables users to users communicate, share content, share files, co-edit files (90).

In a preferred embodiment, the system provides a ranking of users as posters of projects, allowing users to evaluate the attractiveness others the user as collaborators, and allowing NLIs to evaluate users as contributors to the network. The system uses a computer algorithm that uses the activities of the user in the system as inputs and that would apply a weighting to different activities. Below is a list of activities and example weightings (in parentheses) that could be included as inputs to the algorithm
Types and amount of projects posted (10%)
Types and amount of projects responded to (<5%)
Types and amount of collaborators on projects (<5%)
Types and amount of responses to projects (40%)
Types and amount of responders to projects (10%)
Outcomes of projects (completed vs not completed, positive impact vs negative impact) (20%)
Response times to projects posted (<1%)
Duration of collaborations (10%)
Type/categories of files and content that are being shared (<1%)

In a preferred embodiment, the system provides a ranking of users as responders to projects, allowing users to evaluate the attractiveness of other users as collaborators, and allowing NLIs to evaluate users as contributors to the network. The system uses a computer algorithm that uses activities of the user in the system as an input and that would apply a weighting to different activities. The algorithm could be different from that used to rank users as posters (see above). Below is a list of activities and examples weightings (in parentheses) that could be included as inputs to the algorithm
Types and amount of projects posted (<1%)
Types and amount of projects responded to (10%)
Types and amount of collaborators on projects (<5%)
Types and amount of responses to projects (10%)
Types and amount of responders to projects (<5%)
Outcomes of projects (completed vs not completed, positive impact vs negative impact, high quality vs low quality) (30%)
Response times to projects posted (20%)
Start date, end date and/or duration of collaborations (15%)
Type/categories of files and content that are being shared (10%)

In a preferred embodiment, the system provides NLIs a dashboard that gives them platform data and analysis that is most relevant to their target problem (100).

In a preferred embodiment, the system enables NLI to design their own dashboard.

In another embodiment, the system provides a recommendation to the NLI on a set of metrics to be included in the dashboard. The recommendations can be based on various characteristics of the NLI, including relevant geography, relevant population of users, type of organization, and others.

In a preferred embodiment, the system enables NLIs to endorse users, whether they sponsor them or not.

In a preferred embodiment, the system enables NLIs to customize profile inputs, project definition inputs, or project results required for sponsored users. As one example, an NLI who sponsors one set of users, could require that the users that they sponsor fill out all of the profile information shown in (120), while a different NLI, who sponsors a different set of users, could require that the users that they sponsor fill out less information, more information, or different information than that shown in (120). The system would give each NLI options to customize the profile inputs. Likewise the system would give NLI options to customize the project inputs. (130) Likewise the system would give NLI options to customize the project outputs (140)

In a preferred embodiment, the system would enable an NLI who partially or wholly sponsors a set of users to have preferred access to the data generated by the users that they sponsor. That is, they have exclusive access to data generated by the users that they sponsor, or they could have access to the data at a reduced rate, or they could specify what other users or NLIs are allowed to have access to that data. As an example, Sponsor 1 would have preferred access to the data of users A and B shown in the table below, but not of C and D.

| | | Projects | Projects | Projects | Project |
|---|---|---|---|---|---|
| Sponsor | Users | Posted | Responded to | Accepted | outcomes |
| Sponsor1 | A | A1, A2, A3 | B2, B3 | B2 | $XX |
| Sponsor1 | B | B1, B2, B3 | C1 | — | $YY |
| none | C | C1 | A1, B2, D4 | A1, B2, | $ZZ |
| | | | | D4 | |
| none | D | D1, D2, D3, | B2, A1, A2 | A1 | $AA |
| | | D4 | | | |

In another embodiment, the system would enable an NLI to have preferred access to the data generated by a set of users that are not sponsored, i.e. data to which no other users has preferred access to.

In a preferred embodiment, the system enables NLIs to share the data, analysis and insights that they have preferred access to with other users and NLIs. System enables NLIs to provide the information in the form of databases, spreadsheets or analytic charts, or example, in electronic or paper format. These reports could be the result of a specific request by the NLI through the system, or they could be the result of a recommendation from the system. System enables NLIs to do this using the project user interface as in 20, the collaboration user interface as in 40, or through a dedicated interface.

In a preferred embodiment, the system enables users or NLIs to request access to the preferred data, reports, dashboards, and insights from other NLIs or users using project user interface as in 20, the collaboration user interface as in 40, or through a dedicated interface. System enables NLIs to promote the availability of data, reports, dashboards, and insights to other NLIs or users using the project user interface as in 20, or the collaboration user interface as in 40, or through a dedicated interface.

In a preferred embodiment, the system enables users to restrict access to portions of their profile, project, output, or collaboration data, owing to confidentiality restrictions or strategic considerations (150).

In a preferred embodiment, users can integrate tools that improve their capability to be a collaborator or to contribute to network-level objectives, for example for surveying, project management, accounting, video/web conferencing, file sharing, content sharing, fundraising.

In a preferred embodiment, NLIs can provide access to third party platforms to their sponsored user that make their sponsored users more effective in realizing network-level objectives. Examples include tools for surveying, project management, accounting, video/web conferencing, file sharing, content sharing, fundraising.

In the example shown below, the system gives users the option of using Dropbox as a third party file sharing platform (160).

The following is an example use case in workforce development. Educational institutions in a multi-county region decides to form an informal problem solving network to work towards a regional goal of narrowing the gap between the skills and talent that businesses need and the available skills and capabilities in the talent pool. The group consists of high schools, trade schools, community colleges, public universities, private universities. All of the organizations have heard feedback from businesses and community leaders that business growth is limited by their inability to get trained workers, and the institutions themselves have seen job placement numbers decline. Though they trust the feedback, the solutions to address the problem are not clear. The group (the NLIs, in this case) decides to use the present invention as a tool to assist them in solving this problem. A representative from each institutions creates a profile for its institutions as in 10, 110. The Lead Institution creates a project as in 20, posts the project and invites the other institutions as collaborators on that project as in 40. Each of the other institutions requests to collaborate as in 50 and are accepted as in 80. They use this project as a central location to share content and files that are relevant to the overall project, as in 90. Each of the institutions creates their own project as in 20, the scope of which is limited to a narrower geography or specialty area, but which is anticipated to contribute to the broader solution. Each of the institutions invites businesses and community leaders that have provided feedback to them and that have expressed an interest in working on solutions to use the present invention and collaborate on that project. Various businesses sign up for a subscription, which is sponsored by the lead institution in the network, as in 110. The businesses review the list of projects posted as in 40, and request to collaborate on those project that they are interested in as in 50.

The businesses and community leaders are asked by the educational institutions that sponsored them to create their own projects, as in 20. They are prompted to indicate in their project summary what their talent needs are in the short, medium, and long term, 1-6 months, 6 months to 2 years, and 2-5 years respectively. They are prompted to so by a project template that was designed and specified via the system by the Lead Institutions, as in 140.

Educational institutions review the list of projects posted by the businesses or community leaders and:
Request to be added as collaborators to projects on which they can add value, as in 50
or refer the project owners to other people/organizations in the network who they believe can add value, as in 60.
or indicate that they are not interested because they don't think that they can add value, as in 75

They then work with the project owners to address their workforce needs, and in doing so, communicate, share content, and share files with the system, as in 90. Many of them choose to integrate content sharing or file sharing tools that they already use, as in 160. Some of them choose to limit the availability of some of their correspondence, as in 150. As these projects are initiated and collaborations progress, the lead institutions has preferred access to data generated by organizations sponsored in the system. The system provides a dashboard that summarizes this data, as specified by the Lead Institution as in 100. The report includes:
Number of projects initiated by businesses
Number, type, and ranking of collaborators/responders on those projects
Short, medium, and long term needs by business type, by geography, by worker type

The system also provides the Lead Institution with analytic tools such as a trend chart that shows how the above data changes over time. The Lead Institution shares this data with other institutions via its project as in 90. They host a roundtable in which of all the institutions get together to discuss how to respond to the data. They brainstorm concepts for new academic programs (e.g. new high school internship programs in which businesses and high schools collaborate, new transitioning worker training programs, one-on-one consulting) and agree to do pilots on several of them. The group assigns leadership of these pilot programs to different institutions, who create projects as in 20 that notify businesses and community leaders over the system of the availability of the pilot programs.

As these programs progress, the leaders of the pilot programs ask collaborators/user to provide feedback on how effective the pilot programs were for them, as in 130. The users are prompted to input information on how their training costs, position fulfillment, and retention rates for example were impacted by the pilot programs. The template for information was designed by the Lead Institution as in 30. The institution leading each of the pilot programs requests a report via the system showing the aggregate feedback of collaborators on that pilot and the activity of collaborators related to that pilot. Likewise, the Lead Institution requests a report via the system showing feedback and collaboration activity of all of the pilots. The network gets back together, reviews the information, analysis, and reports made available via the platform, and discusses which of the programs should become permanent as is, which need some changes, and which will be discontinued. The institutions develop a plan taking all of the above into account, and reports out the plan to various collaborators via the lead project they created in the system.

After implementation of the new programs into the network, the Lead Institution and partner institutions are able to continue to monitor progress toward whatever goals they have set for the network, and are able to pilot, implement, and evaluate new programs in a way similar to above as needs in the region change over time.

What is claimed is:

1. A computer-implemented method for dynamically adjusting a graphical interface for network level modeling of need-based projects between a first network and a second network based on comparing individually weighted user inputs through a graphical interface for individual users, the method comprising:
receiving from a first user need-based information through the graphical interface for individual users;
ranking said first user based on a history of said first user and said received need-based information;
displaying a subset of said first user need-based information through the graphical interface for individual users;
receiving from a second user resource information through the graphical interface for individual users;
ranking said second user based on a history of said second user and said received resource information;
receiving from a third user resource information through the graphical interface for individual users;
ranking said third user based on a history of said third user and said received resource information;
constantly monitoring for interactions between said first user, said second user, and said third user, wherein said interactions between said first user, said second user, and said third user all occur within the first network;
receiving from a fourth user need-based information through the graphical interface for individual users;
ranking said fourth user based on a history of said first user and said received need-based information;
displaying a subset of said fourth user need-based information through the graphical interface for individual users;
receiving from a fifth user resource information through the graphical interface for individual users;
ranking said fifth user based on a history of said second user and said received resource information;
receiving from a sixth user resource information through the graphical interface for individual users;
ranking said sixth user based on a history of said third user and said received resource information;
constantly monitoring for interactions between said fourth user, said fifth user, and said sixth user, wherein said interactions between said fourth user, said fifth user, and said sixth user all occur within the second network;
distinguishing between interactions on the first network and the second network; and
reporting of activities of said first user, said second user, said third user, said fourth user, said fifth user, and said sixth user as they pertain to the interests of the said first network and said second network.

2. A computer-implemented method for dynamically adjusting a graphical interface for network level modeling of need-based projects based on comparing individually weighted user inputs through a graphical interface for individual users, the method comprising:
receiving from a first user need-based information through the graphical interface for individual users;
ranking said first user based on a history of said first user and said received need-based information;
displaying a subset of said first user need-based information through the graphical interface for individual users;
receiving from a second user resource information through the graphical interface for individual users;
ranking said second user based on a history of said second user and said received resource information;
receiving from a third user resource information through the graphical interface for individual users;
ranking said third user based on a history of said third user and said received resource information;
constantly monitoring for interactions between said first user, said second user, and said third user;
mapping interactions between said first user, said second user, and said third user;
automatically identifying whether an aggregate of all received need-based information contains any deficits or surpluses; and
adjusting the graphical interface for network level modeling to reflect said aggregate of deficits or surpluses.

3. A computer-implemented method for analyzing the effectiveness of an informal problem solving network and implementing and evaluating improvements to the network, the method comprising:
prompting users in the informal problem solving network to post their needs for assistance;
restricting the posting of needs to users that would contribute to a solution of a broader problem to be solved by the informal problem solving network;
indicating to users of the informal problem solving network that relevant needs have been posted;
providing indicators of the credibility of users in the informal problem solving network;
facilitating interactions between users of the informal problem solving network;
identifying activities of users and interactions between users that are relevant to the, and the characterization of the degree to which those interactions are relevant to the informal problem solving network;
distinguishing between users, activities, inputs, and project outputs across different informal problem solving networks that are using the system prompting of users to report outcomes of interactions;
aggregating and analyzing data on all interactions reported between users;
generating reports on interactions between users and reported outcomes at those users that enable a network level interest to determine progress of the informal problem solving network ;
identification of improvements to the informal problem solving network, based on analysis of the activities of the users and the outcomes; and
distributing reports to said network level interest for which access has been granted.
